(19) United States
(12) Patent Application Publication
(10) Pub. No.: US 2007/0164612 A1
(43) Pub. Date: Jul. 19, 2007

(54) Decentralized power generation system

(75) Inventors: Mathias Wendt, Wurselen (DE); Peter Lurkens, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninkijke Phillips electronics N.V.

(21) Appl. No.: 10/585,368

(22) PCT Filed: Dec. 21, 2004
(86) PCT No.: PCT/IB04/52877

§ 371 Date: Jul. 5, 2006

(30) Foreign Application Priority Data
Jan. 9, 2004 (EP) 04100049.8

(51) Int. Cl. H02J 1/12

(52) U.S. Cl. 307/45

(57) ABSTRACT

The invention relates to a decentralized power generation system comprising a plurality of decentralized power generating units (11,12;13,14). In order to enable an optimized control of these power generating units while enabling at the same time a high security in the system, it is proposed that the system further comprises a plurality of DC/DC converters (31,32), each connected to another one of the power generating units for converting a current provided by the power generating units. The proposed system moreover comprises a DC bus (40) to which the DC/DC converters feed a respectively converted current. The proposed system moreover comprises at least one power receiving component (20) retrieving current from the DC bus, which power receiving component is physically separated from the DC/DC converters. The invention relates equally to a corresponding method.

The invention relates to a decentralized power generation system comprising a plurality of decentralized power generating units. The invention relates equally to a method of operating such a decentralized power generation system.

Decentralized power generation systems are known for example in the form of photovoltaic (PV) power plants.

Photovoltaic power is one of the most promising sources for renewable energy. In PV power plants, PV cells generate a direct current, which results in a low direct voltage of less than 1 V at each cell. Usually, a plurality of PV cells are therefore assembled in a PV module. Depending on the mode of implementation, such a PV module may have an output voltage of several tens of Volt and provide a power of 10 W to 150 W.

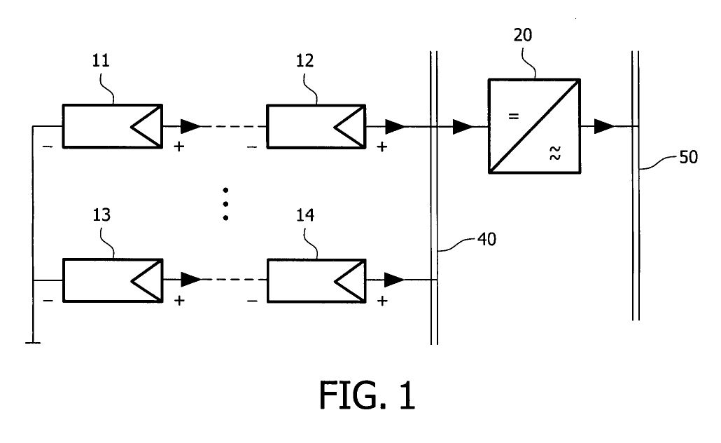

In some applications, for example in PV power plants which are arranged for feeding generated current into a public power supply system, the direct current provided by the PV modules is further converted by an inverter into an alternating current, as illustrated in FIG. 1.

FIG. 1 is a block diagram of a conventional PV power plant. The power plant comprises a first series connection of several PV modules 11 to 12 and a second series connection of several PV modules 13 to 14. The series connection of the PV modules 11 to 12 on the one hand and the series connection of the PV modules 13 to 14 on the other hand are arranged in parallel to each other between ground and a direct current (DC) bus 40. Moreover, an inverter 20 is connected on the one hand to the DC bus 40 and on the other hand to lines 50 of a public power supply system.

In such a system, various controlling tasks have to be taken care of.

In order to operate the PV modules 11 to 14 at an optimal operating point, advantageously a so-called MPP (Maximum Power Point) tracking is employed. The MPP tracking selects the input current to the inverter 20 such that the PV cells have their MPP. This MPP, however, is not fixed but varies, for example, with the intensity of the solar radiation, with the temperature and with the characteristics of the PV cells.

Moreover, the electrical power provided by the PV cells to the inverter 20 has to be adapted by the inverter 20 to the current voltage in the public power supply system, to the current frequency in the public power supply system and to the current phase in the in the public power supply system, before it is fed into the system. Supplementary circuits moreover take care of the safety of the operation and prevent, for instance, that the operation of the inverter 20 is continued if the voltage of the public power supply system fails, in order to prevent an isolated operation of the PV power plant.

In conventional PV power plants, the voltage adaptation at the input of the inverter and the inverter circuit itself are realized in a single device.

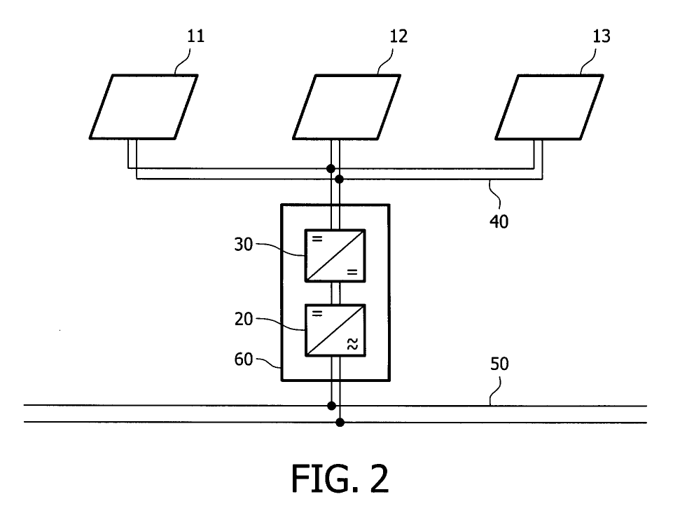

FIG. 2 is a block diagram of a conventional PV power plant using a central inverter unit 60. The PV power plant comprises a plurality of PV modules 11, 12, 13. Each of these PV modules 11, 12, 13 is connected, for example via a DC bus 40, to the inputs of the central inverter unit 60. Instead of a plurality of single PV modules 11, 12, 13, also a plurality of series connections of PV modules could be used, as shown in FIG. 1. Within the central inverter unit 60, the PV modules 11, 12, 13 are connected via a DC/DC converter 30 to the actual inverter 20. The outputs of the inverter 20 correspond to the outputs of the central inverter unit 60, which are connected to lines 50 of a public power supply system.

In case such a central inverter unit 60 is employed in a larger system, the MPP tracking can only be realized for the PV power plant as a whole. Consequently, there is no possibility of reacting flexibly to environmental influences limited to single or specific ones of the PV modules 11, 12, 13, for example a partial shadowing of the PV modules 11, 12, 13.

A further problem with a central inverter unit 60 is due to the high voltages and the high direct currents which have to be fed from the PV modules 11, 12, 13 to the central inverter unit 60. Currents exceeding some Ampere cannot be separated any more with simple fuses in case of voltages exceeding 40 V. This implies that in case of sunshine, the PV power plant cannot be switched off on the direct current side. In addition, the PV modules 11, 12, 13 always provide a voltage as long as they are illuminated. That is, if they are not connected to a load, they provide nevertheless a no-load voltage. This has to be taken into account during assembly and maintenance of the PV power plant, in order to avoid accidents and damages.

In the publication DE 199 19 766 A1, it has been proposed to use a central inverter unit with a separate DC/DC converter for a respective series connection of PV modules. This allows a separate voltage adaptation and a separate MPP tracking for each series connection. The above described problem of high direct currents and no-load voltages, however, is not solved with this approach.

In other conventional PV power plants, several inverter units are employed, each comprising a DC/DC converter and an inverter. Each of these inverter units is then associated to another PV module or to another assembly of PV modules. The inverter units are usually mounted close to the associated PV module or assembly of PV modules, in order to avoid long direct-current paths. In practice, in particular PV power plants are offered, in which each PV module is provided with its own inverter unit, forming a so called module-inverter. Such a PV power plant has been presented for example in the publication DE 40 32 569 A1.

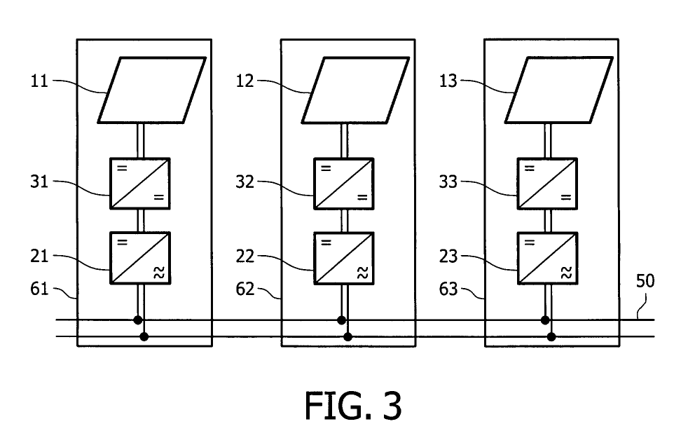

FIG. 3 is a block diagram of a conventional PV power plant using module-inverters. The depicted PV power plant comprises a first module-inverter 61, in which a first PV module 11 is connected via a first DC/DC converter 31 to a first inverter 21. The outputs of the inverter 21 are further connected to lines 50 of a public power supply system. The PV power plant comprises in addition a plurality of further module-inverters 62, 63, which are constructed and arranged in the same manner as the first module inverter 61 and which thus comprise a respective PV module 12, 13, a respective DC/DC converter 32, 33 and a respective inverter 22, 23.

It is a disadvantage of this PV power plant that each inverter 21, 22, 23 has to take care independently of the demands on feeding a current into the public power supply system. In some cases, even a surveillance of network failures and security circuits are implemented separately in each of the module-inverter 61, 62. 63. Moreover, the distributed inverters 21, 22, 23 have to be connected to a separate communication structure, if they have to be surveyed and/or controlled from a central location. In addition, the control algorithms in the inverters 21, 22, 23 may become unstable, when they cause each other to oscillate.

A further disadvantage of the PV power plant presented in FIG. 3 is the insufficient reliability of the inverters 21, 22, 23 resulting from the environmental strain when mounted on a roof top. An inverter 21, 22, 23 requires electrolyte capacitors for storing energy over the 50 Hz cycle of the voltage on the public power supply system, and such electrolyte capacitors are particularly sensitive to variations in temperature.

It has to be noted that similar problems may occur in other types of decentralized systems for power generation, which employ other decentralized power generating units than PV modules or assemblies of PV modules. Further, similar problems may equally occur if the energy generated by decentralized power generating units, like PV modules, is not to be used for feeding into a public power supply system but for some other purpose.

It is an object of the invention to improve a decentralized power generation system. It is in particular an object to enable an optimized control of power generating units while enabling at the same time a high security in the system.

On the one hand, a decentralized power generation system is proposed, which comprises a plurality of decentralized power generating units. The proposed system further comprises a plurality of DC/DC converters, each of the DC/DC converters being connected to another one of the power generating units for converting a current provided by the power generating units. The proposed system further comprises a DC bus to which each of the DC/DC converters is coupled for feeding a respectively converted current into the DC bus. The proposed system finally comprises at least one power receiving component connected to the DC bus for retrieving current from the DC bus, which power receiving component is physically separated from the DC/DC converters.

On the other hand, a method of operating a decentralized power generation system is proposed for a system which comprises a plurality of decentralized power generating units, a plurality of DC/DC converters, a DC bus and at least one power receiving component, which is physically separated from the DC/DC converters. The proposed method comprises the steps of:
generating a current by means of the plurality of power generating units;
converting the current provided by each of the power generating units by means of a respective DC/DC converter; and
providing current from the DC bus to the at least one power receiving component.

The invention proceeds from the idea that the functions of a plurality of DC/DC converters among each other and the functions of a power receiving component can be distributed to several, physically separated units. In contrast to known solutions, the invention thus proposes to associate a separate DC/DC converter to each of a plurality of power generating units and to provide the converted current output by the DC/DC converters via a DC bus to at least one physically separated power receiving component.

The invention thereby combines the advantages of the known systems and avoids at the same time their disadvantages.

Compared to the system of document DE 199 19 766 A1, it is an advantage of the invention that high direct currents provided by the power generating units do not have to be transferred a long way to a central power receiving unit, since the high direct currents can be converted immediately by the DC/DC converter associated to the respective power generating unit. Further, the invention enables a particularly simple modular and extendible mounting of the system.

Compared to the system of document DE 40 32 569 A1, it is an advantage of the invention that those components of the system which are subject to adverse environmental conditions, for instance on a roof, can be constructed without electrolyte capacitors and thus in a way which ensures a long life and a high reliability. That is, the DC/DC converters can be arranged close to the power generating units, which may be subject to adverse environmental conditions, while the more sensitive power receiving component can be arranged at a sheltered location. Expensive components in the DC/DC converters can be avoided.

In one embodiment of the invention, each of the DC/DC converters is adapted to operate autonomously, the only external requirement on them being to ensure a predetermined voltage on the DC bus. In this case, a communication between a central control unit and the DC/DC converters is not necessary, and even DC/DC converters and power generating units from different manufacturers, of different types and of different generations could be employed.

Each power generating unit may comprise a plurality of energy supply modules, for example a plurality of PV modules connected to each other in series. If several modules are combined in a series connection in a power generating unit, however, they should be of the same construction and the same age and, in the case of PV modules, be mounted with the same illumination conditions, in order to avoid a reduction of their efficiency. Therefore, in a further embodiment of the invention, each power generating unit comprises only a single energy supply module, for example a single PV module, which can be controlled independently by an associated DC/DC converter.

Each DC/DC converter can also be coupled mechanically to the associated power generating unit. If a DC/DC converter is coupled mechanically to a power generating unit, for instance by being arranged in a single constructive unit with an energy supply unit, a simple potential separation can be achieved between the DC bus and the energy supply units. In the case of large scale systems, thereby the problem of capacitive currents to ground are avoided. Such currents might otherwise lead to an undesired activation of a fault-current circuit breaker. Moreover, a potential separation in the power receiving component will usually not be required this way.

In a further embodiment of the invention, the at least one power receiving component is adapted to survey a voltage on the DC bus and to reduce the power retrieved from the DC bus when the voltage on the DC bus is detected to be decreasing. This approach allows an automatic regulation of the amount of power which can be retrieved from the DC bus given the current capacities of the power generating units. It does not require a communication between the power receiving component and the power generating units, for example via a central control unit.

In a further embodiment of the invention, the decentralized power generation system comprises in addition at least one control line connecting each of the DC/DC converters to the at least one power receiving component. The at least one control line is arranged for switching on and off the DC/DC converters, for instance by providing and interrupting the supply power to the DC/DC converters, respectively.

In a further embodiment of the invention comprising such a control line, the decentralized power generation system moreover comprises at least one plug connection for electrically connecting the DC/DC converters on the one hand to the DC bus and on the other hand via the control line to the at least one power receiving component. This arrangement ensures that the control line can only become active when the power generating units are connected to the DC bus. Such a plug connection therefore ensures a contact safety during mounting and service, provides a protection from electric arcs, and enables an automatic switching off without requiring additional components.

Advantageously, the plug connection is realized such that when closing the connection, a power generating unit is connected first to the DC bus and only thereafter to the power receiving component, and when releasing the connection, a power generating unit is disconnected first from the power receiving component and only then from the DC bus. This arrangement ensures that the DC/DC converter is only switched on when the power generating units are securely connected to the DC bus. The security is further improved, if the plug connection is realized such that it comprises a locking mechanism which ensures that a control line is only activated with a closed plug connection when in addition the locking mechanism is locked.

The invention can be used in any decentralized energy generation system using a plurality of power generating units. The power generating units can comprise PV modules or any other power generating modules. Different power generating units may even comprise different types of power generating modules, in particular if the DC bus has a predetermined operating voltage range which is observed by the power generating units.

Moreover, the current fed by the plurality of DC/DC converters into the DC bus can be supplied to any desirable power receiving component. It can be supplied for instance to an inverter for converting the supplied direct current into an alternating current in accordance with specific requirements. The alternating current can then be fed for example into a public power supply system or be used as power supply in an isolated power supply system. In case the alternating current is to be fed into a public power supply system, the different national rules for supplying energy into the public power supply system only have to be taken care of in the central inverter.

Alternatively, the current on the DC bus could also be retrieved, for example, by a charging controller for accumulators. In a system provided with accumulators, the DC bus could be used for supplying the charging current, but equally be used in de-charging cycles. That is, the energy provided by the power generating units via the DC bus could be supplied to some load and charge in parallel one or more accumulators via the charging controller. In case of a decreasing voltage on the DC bus, energy stored in the accumulators may then be fed back to the DC bus in order to enable the load to continuously retrieve energy from the DC bus.

In the following, embodiments of the invention will be described in more detail by way of example with reference to the accompanying drawings of which:

FIG. 1 is a block diagram showing a serial-parallel connection of PV modules in a conventional PV power plant;

FIG. 2 is a block diagram of a conventional PV power plant using a centralized inverter;

FIG. 3 is a block diagram of a conventional PV power plant using module-inverters;

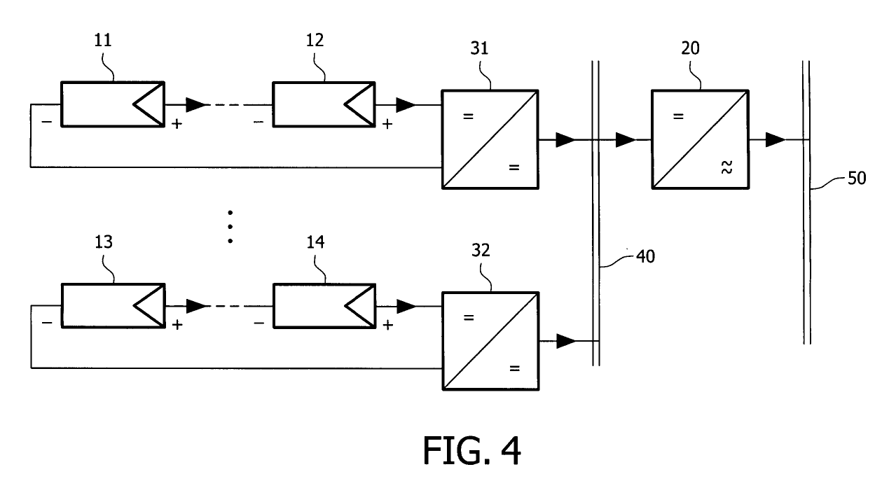

FIG. 4 is a block diagram of a first embodiment of a PV power plant according to the invention;

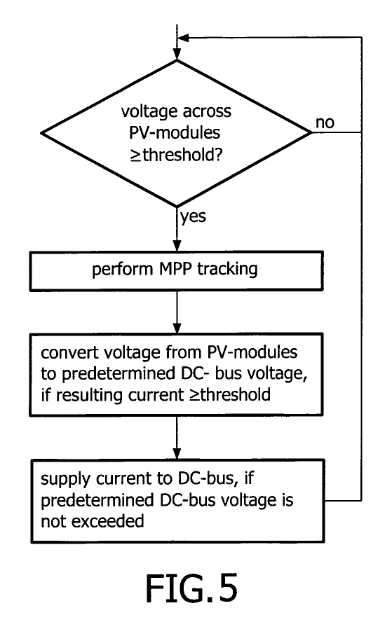

FIG. 5 is a flow chart illustrating the operation of a DC/DC converter in the power plant of FIG. 4;

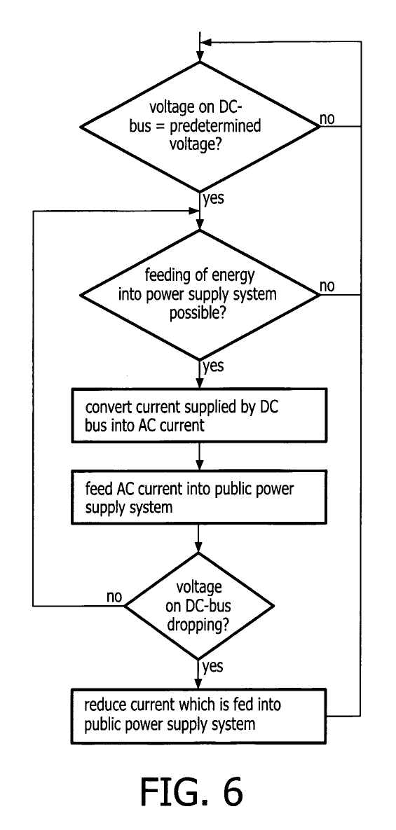

FIG. 6 is a flow chart illustrating the operation of an inverter in the power plant of FIG. 4;

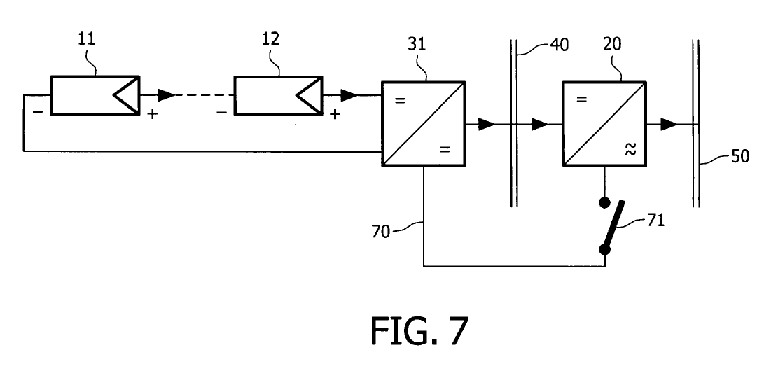

FIG. 7 is a block diagram showing details of a second embodiment of a PV power plant according to the invention;

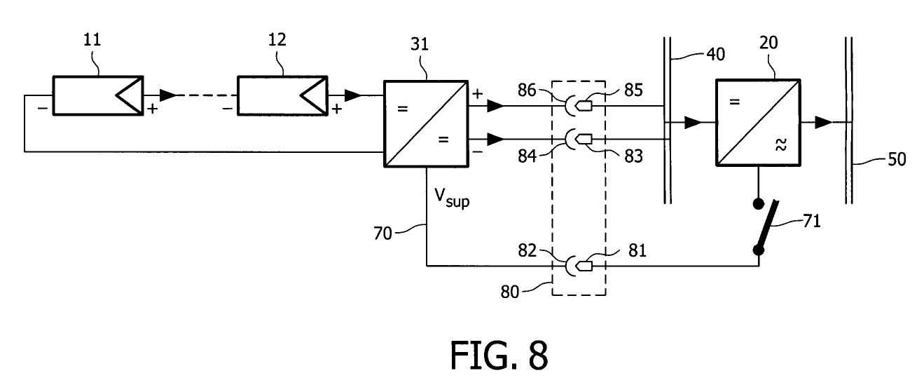

FIG. 8 is a block diagram showing details of a third embodiment of a PV power plant according to the invention; and

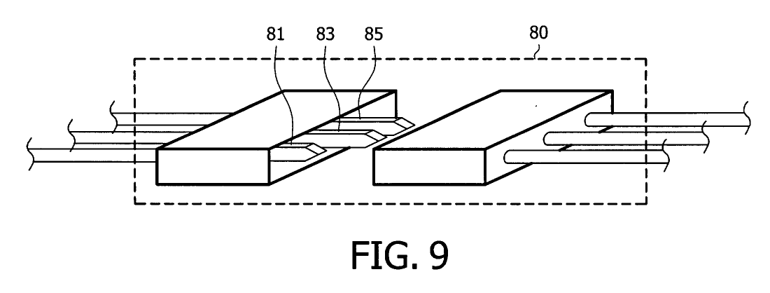

FIG. 9 is a block diagram showing a connector which can be used in the third embodiment of the invention.

FIG. 4 is a block diagram of a PV power plant constituting an embodiment of a decentralized power supply system according to the invention.

The PV power plant comprises a first series connection of PV modules 11, 12. Both ends of this first series connection are connected to the inputs of a first DC/DC converter 31. The PV power plant further comprises a second series connection of PV modules 13, 14. Both ends of this second series connection are connected to the inputs of a second DC/DC converter 32. The respective outputs of the DC/DC converters 31, 32 are connected to the lines of a common DC bus 40. Further PV modules can be connected in the same way via separate DC/DC converters to the DC bus 40. The PV power plant finally comprises an inverter 20. The inputs of the inverter 20 are equally connected to the lines of the DC bus 40, while the outputs of the inverter 20 are connected to lines 50 of a public power supply system.

The operation of the PV power plant will now be described with reference to FIGS. 5 and 6. FIG. 5 is a flow chart illustrating the operation in the DC/DC converters 31, 32, and FIG. 6 is a flow chart illustrating the operation in the inverter 20.

The PV-modules 11 to 14 produce a current depending on a respective intensity of illumination.

The DC/DC converters 31, 32, which receive their supply voltage from the respectively connected PV modules 11 to 14, survey the voltage provided by the PV modules 11 to 14. As soon as a predetermined threshold value is reached or exceeded by the voltage supplied by a specific series connection of PV modules 11 to 14, the associated DC/DC converter 31, 32 carries out a voltage conversion. Using the conventional MPP tracking, the input current to this DC/DC converter 31, 32 is set such that the connected PV modules 11 to 14 are operated in the bend of the characteristic curve, i.e. in the MPP. The MPP tracking is thus performed separately for each series connection of PV modules 11 to 14.

The output power of the DC/DC converters 31, 32 is supplied to the DC bus 40. Two requirements determine the amount of power which each DC/C converter 31, 32 is allowed to supply to the DC bus 40. As a first requirement, the output voltage of the DC/DC converters 31, 32 is set to a predetermined voltage, which is the same for each DC/DC converter 31, 32 of the entire PV power plant. As a second requirement, the current provided by a DC/DC converter 31, 32 is not allowed to exceed a predetermined maximum value. This maximum value can be different for each DC/DC converter 31, 32 and should be selected depending on the maximum power of the respectively connected PV modules 11 to 14. Thus, a DC/DC converter 31, 32 supplies energy to the DC bus 40 only if its output current is below a threshold value predetermined for this DC/DC converter 31, 32 and if the supply of energy does not increase the voltage on the DC bus 40.

The inverter 20, which is connected to the DC bus 40, recognizes that at least one of the DC/DC converters 31, 32 is operating, if the predetermined voltage is available on the DC bus 40. If the predetermined voltage is available on the DC bus 40 and if a surveillance of the voltage on the lines 50 of the public power supply system currently allows such a supply, the inverter 20 may convert current retrieved from the DC bus 40 into an alternating current having a required frequency and a required code phase, and feed this alternating current into the lines 50 of the public power supply system.

The more energy is fed by the inverter 20 into the public power supply system, the higher rises the current on the DC bus 40, as the DC/DC converters 31, 32 may supply more energy without raising the voltage on the DC bus 40. Only when all DC/DC converters 31, 32 have reached their maximum load, the voltage on the DC bus 40 starts to drop. This is a signal to the inverter 20 to reduce the energy supplied to the public power supply system. The inverter 20 thus learns indirectly via the voltage on the DC bus 40 that the energy supplied to the public power supply system is too high compared to the energy generated in the PV modules 11 to 14 and that the supply has to be reduced. When the inverter 20 reaches its maximum supply power before the voltage on the DC bus 40 drops, no problem will occur, since the DC/DC converters 31, 32 are not enabled to increase the voltage on the DC bus 40.

With the described control mechanism, the DC/DC converters 31, 32 can thus be controlled independently from each other.

In a failure situation, moreover a very simple switching off of the PV power plant is ensured. If the inverter 20 is switched off, the DC/DC converters 31, 32 cannot supply their energy to the DC bus 40 anymore without causing the voltage on the DC bus 40 to exceed the predetermined voltage. As a consequence, also the DC/DC converters 31, 32 switch off their energy transport.

The presented PV power plant has further the advantage that the DC/DC converters 31, 32 required basically no buffering of energy. Therefore, no electrolyte capacitors, which reduce the durability of a device, are required in the DC/DC converters 31, 32.

It has to be noted that the described control mechanism would also supports the employment of several inverters connected in parallel to the DC bus 40.

Each inverter is then able to recognize an overload on the DC bus 40 from the reduction of the voltage on the DC bus 40. Up to this point, each of the inverters can draw energy up to its allowed maximum energy from the DC bus 40.

A variation of the PV power plant of FIG. 4 is presented in the block diagram of FIG. 7. The PV power plant of FIG. 7 constitutes a second embodiment of a decentralized power supply system according to the invention, which avoids a disadvantage in the PV power plant of FIG. 4. Since the DC/DC converters 31, 32 in the PV power plant of FIG. 4 are supplied with energy by the PV modules 11 to 14, the DC/DC converters 31, 32 start to operate as soon as the illumination of the PV modules 11 to 14 reaches a sufficient intensity. This is also the case during the mounting of the PV power plant, such that a resulting voltage on the DC bus 40 exposes the mounting personnel to danger.

The structure of the PV power plant of FIG. 7 corresponds exactly to the structure of the PV power plant of FIG. 4, except that each DC/DC converter 31 is connected via an additional control line 70 with the inverter 20. In FIG. 7, only one series connection of PV modules 11, 12 and one DC/DC converter 31 of the PV power plant are shown. In case of a plurality of DC/DC converters 31, 32, each of these converters 31, 32 may be connected to the same control line 70. The control line 70 comprises one or more switches 71. The switch 71 is used for switching the DC/DC converter 31 on and off. DC/DC converters are only able to operate if they receives a supply power. In the presented embodiment, the DC/DC converter 31 may in particular not be supplied with this supply power from the PV modules 11, 12, but via the control line 70. The switch 71 in the control line 70 can then be used for interrupting the energy supply to the DC/DC converter 31 for switching it off whenever required.

The embodiment presented in FIG. 7 thus allows to remove the voltage in the PV power plant easily and reliably during mounting or during service activities.

A further improvement of security can be achieved with a structure of a PV power plant as presented in the block diagram of FIGS. 8. The PV power plant of FIG. 8 constitutes a third embodiment of a decentralized power supply system according to the invention, and FIG. 9 shows details of this PV power plant.

FIG. 8 presents a part of a PV power plant which comprises the same components as the PV power plant presented in FIG. 7. Here, however, a plug 80 is provided in addition for connecting the DC/DC converter 31 on the one hand to the DC bus 40 and on the other hand to the inverter 20 via a control line 70. One part of the plug 80 comprises a contact 82 connected via a section of the control line 70 to the DC/DC converter 31 and two contacts 84, 86 connected to the outputs of the DC/DC converter 31. Another part of the plug 80 comprises correspondingly a contact 81 connected via another section of the control line 70 to the inverter 20 and two contacts 83, 85 connected to a respective line of the DC bus 40. For each DC/DC converter 31, 32 in the PV power plant, a separate plug 80 may be provided.

The plug 80 ensures during mounting and service that the control line 70 can only become active when the lines of the DC bus 40 have been connected and there is no longer a danger of contact. A part of the PV power plant which is not connected to the DC bus 40 is automatically switched off, and power lines are connected before any current can be output by a respective DC/DC converter 31, 32.

FIG. 9 presents an embodiment of a plug 80 which can be used advantageously in the PV power plant of FIG. 8.

The plug 80 comprises two parts, which can be connected to each other. One of the parts comprises three contact pins 81, 83, 85, which are inserted for a connection into the other part of the plug 80 comprising corresponding receiving contacts 82, 84, 86 (not shown). One of the contact pins 81 is shorter than the other two contact pins 83, 85. The longer contact pins 83, 85 are connected to the two lines of the DC bus 40, while the shorter contact pin 81 is connected via the control line 70 to the inverter 20. When connecting the two parts of the plug 80, the longer contact pins 83, 85 form an electrical contact with the corresponding receiving contacts 84, 86 before the shorter contact pin 81 forms an electrical contact with the corresponding receiving contact 82.

When connecting the plug 80, the lines of the DC bus 40 used for the energy transmission are thus connected first, and the control line 70 is connected somewhat later. When disconnecting the plug 80, the order of disconnection is reverse. This ensures that the DC/DC converter 31 will only be switched on, when the DC bus 40 is securely connected and when no danger of contact remains. Further, the DC/DC converter 31 will already be switched off, when the electrical connection to the DC bus 40 is released. An electric arc does not occur, since the current is already decreasing.

The connection between the two sections of the control line 70 via the plug 80 can be combined mechanically with a plug lock (not shown), which has to be released before the plug 80 can be disconnected completely. Thereby, it can be ensured that the DC/DC converter 31 has sufficient time for switching off, in order to avoid disruption sparks in a reliable way.

It is understood that the described embodiments of the invention represents only some of a great variety of possible embodiments of the invention.

1. Decentralized power generation system, said system comprising:
a plurality of decentralized power generating units;—a plurality of DC/DC converters, each of said DC/DC converters being connected to another one of said power generating units for converting a current provided by said power generating units;—a DC bus to which each of said DC/DC converters is coupled for feeding a respectively converted current into said DC bus; and—at least one power receiving component connected to said DC bus for retrieving current from said DC bus, which power receiving component is physically separated from said DC/DC converters.

2. Decentralized power generation system according to claim 1, wherein each of said DC/DC converters is adapted to operate autonomously and to ensure a predetermined voltage on said DC bus.

3. Decentralized power generation system according to claim 1, wherein each of said decentralized power generating units is mechanically coupled to a respective DC/DC converter.

4. Decentralized power generation system according to claim 1, wherein said power receiving component is adapted to survey a voltage on said DC bus and to reduce the power retrieved from said DC bus when the voltage on said DC bus is detected to be decreasing.

5. Decentralized power generation system according to claim 1, further comprising at least one control line connecting each of said DC/DC converters to said at least one power receiving component, which at least one control line is arranged for switching on and off said DC/DC converters.

6. Decentralized power generation system according to claim 5, further comprising at least one plug connection for electrically connecting a respective DC/DC converter in common to said DC bus and, via said control line, to said at least one power receiving component.

7. Decentralized power generation system according to claim 6, wherein said at least one plug connection is adapted to electrically connect a respective DC/DC converter to said DC bus before connecting said DC/DC converter via said control line to said at least one power receiving component and to interrupt the connection between said DC/DC converter via said control line to said at least one power receiving component before disconnecting said DC/DC converter from said DC bus.

8. Decentralized power generation system according to claim 1, wherein said power receiving component is an inverter arranged to convert a direct current retrieved from said DC bus into an alternating current and to feed said alternating current into an alternating current power supply system.

9. Decentralized power generation system according to claim 1, wherein each of said power generating units comprises at least one photovoltaic module.

10. Method of operating a decentralized power generation system, which system comprises a plurality of decentralized power generating units, a plurality of DC/DC converters, a DC bus and at least one power receiving component, which is physically separated from said DC/DC converters, said method comprising:
generating a current by means of said plurality of power generating units;
converting the current provided by each of said power generating units by means of a respective DC/DC converter;—feeding said converted currents into said DC bus; and
providing current from said DC bus to said at least one power receiving component.
